(19) United States
(12) Patent Application Publication
(10) Pub. No.: US 2009/0232215 A1
(43) Pub. Date: Sep. 17, 2009

(54) Method and an Apparatus for Encoding or Decoding a Video Signal

(75) Inventors: Seung Wook Park, Seoul (KR); Jung Sun Kim, Seoul (KR); Joon Young Park, Seoul (KR); Young Hee Choi, Seoul (KR); Byeong Moon Jeon, Seoul (KR); Yong Joon Jeon, Seoul (KR)

Correspondence Address: FISH & RICHARDSON P.C., P.O. BOX 1022, MINNEAPOLIS, MN, 55440-1022, US

(73) Assignee: LG Electronics Inc., Seoul (KR)

(21) Appl. No.: 12/401,504

(22) Filed: Mar. 10, 2009

Related U.S. Application Data
(60) Provisional application No. 61/035,746, filed on Mar. 12, 2008.
(60) Provisional application No. 61/036,085, filed on Mar. 13, 2008.
(60) Provisional application No. 61/120,486, filed on Dec. 8, 2008.

(30) Foreign Application Priority Data
Mar. 9, 2009 (KR) 10-2009-0019808

(51) Int. Cl. H04N 7/32; H04N 7/26

(52) U.S. Cl. 375/240.16; 375/240.12; 375/E07.125; 375/E07.243

(57) ABSTRACT

A method of processing a video signal is disclosed. The present invention includes determining an intra prediction mode of a current block using a template region adjacent to the current block and obtaining a prediction value of the current block using the intra prediction mode of the current block. Accordingly, the present invention raises efficiency of video signal processing by enabling a decoder to derive information on a prediction mode of a current block in a decoder instead of transferring the information to the decoder.

### PRIORITY APPLICATIONS

This patent application claims the benefit of priority from the following Korean and U.S. patent applications each of which is incorporated by reference herein in its entirety:
U.S. Provisional Patent Application No. 61/035,746, filed Mar. 12, 2008;
U.S. Provisional Patent Application No. 61/036,085, filed Mar. 13, 2008;
U.S. Provisional Patent Application No. 61/120,486, filed Dec. 8, 2008; and
Korean Patent No. 10-2009-0019808, filed Mar. 9, 2009.

### RELATED APPLICATION

This application is related to U.S. Provisional Patent Application No. 61/035,015, filed Mar. 9, 2008, which provisional patent application is incorporated by reference herein in its entirety.

### TECHNICAL FIELD

The present invention relates to an apparatus for encoding or decoding a video signal and method.

### BACKGROUND

When source provider transmits an encoded video signal to a decoder, a method of removing temporal redundancy and spatial redundancy is used to enhance a compression ratio of a video signal, i.e., an intra predicting method and an inter predicting method are used.

### SUMMARY

An object of the present invention is to reduce a bit size allocated to inter prediction mode.

Another object of the present invention is to obtain a more precise motion vector by maintaining a transmitted motion vector size unchanged.

Another object of the present invention is to raise accuracy of inter prediction.

Another object of the present invention is to use template matching adaptively according to a template region range.

A further object of the present invention is to process a video signal efficiently by proposing a method of using a flag indicating whether to perform template matching.

### Technical Solution

The present invention is characterized in that a decoder derives an intra prediction mode of a current block using a template region without transmitting the intra-prediction mode to the decoder.

The present invention is characterized in obtaining a motion vector by performing a conventional block matching algorithm and in performing template matching between blocks adjacent to a reference block pointed by the motion vector in a reference flame and a current block.

The present invention is characterized in obtaining a motion vector of a current block by reducing accuracy of a motion vector difference value in transmitting a motion vector difference value of a current block to a decoder and the decoder obtains a motion vector of the current block by performing template matching by a motion vector in quarter-pel unit.

The present invention is characterized in considering an illumination intensity difference between a current frame and a reference frame, adding an additional value to a template region of a candidate reference block and performing a template matching between a current block and a candidate reference block to find a reference block corresponding to a current block using template matching.

The present invention is characterized in setting a template region by enabling a shape resulting from combining a target region and a template region to have the same shape of a target in case of template matching.

The present invention is characterized in using a flag indicating whether to perform template matching and in using a flag for each partition within a macroblock.

The present invention is characterized in performing a conventional decoding process by obtaining flag information indicating whether to perform the template matching, before a decoder obtains a type of a macroblock, and is also characterized in setting a type of a macroblock to 16*16 and setting a type of a sub-macroblock to 8*8 in case of performing the template matching.

The present invention is characterized in extending a template region up to an already-coded block adjacent to a right side or lower end edge of a target as well as blocks respectively adjacent to a left side and upper end edge of the target.

### Advantageous Effects

Accordingly, the present invention provides the following effects or advantages.

First of all, the present invention is able to reduce a bit size transmitted to a decoder in a manner that the decoder derives an intra prediction mode of a current block using a template region without transmitting the intra prediction mode to the decoder, thereby enhances coding efficiency of video signal processing.

Secondly, in obtaining a motion vector of a current block, the present invention obtains a motion vector of a current block using a conventional block matching algorithm but is able to obtain a more precise motion vector by performing template matching based on the motion vector, thereby raising coding efficiency of video signal processing.

Thirdly, the present invention reduces a motion vector information size transmitted to a decoder by transmitting a motion vector difference value of a current block in a manner of reducing accuracy of the motion vector difference value and obtaining the motion vector of the current block by performing template matching by a motion vector in quarter-pel unit in the decoder, thereby raising coding efficiency of video signal processing.

Fourthly, in case of considering an illumination intensity difference in finding a reference block corresponding to a current block using template matching, the present invention is able to raise accuracy of current block prediction.

Fifthly, the present invention sets a template region by enabling a shape resulting from combining a target region and a template region to have the same shape of a target, thereby raising coding efficiency of video signal processing.

Sixthly, the present invention uses a flag indicating whether to perform template matching and uses a flag for each partition within a macroblock, thereby raising coding efficiency of video signal processing.

Seventhly, the present invention skip to decode a macroblock type by obtaining flag information indicating whether to perform the template matching, before a decoder obtains a type of a macroblock, thereby raising coding efficiency of video signal processing.

Eighthly, the present invention extends a template region up to an already coded block adjacent to a right side or lower end edge of a target in template matching as well as blocks respectively adjacent to a left side and upper end edge of the target, thereby raising coding efficiency of video signal processing that uses the template matching.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows an example of a template region and a target region;

FIG. 2 is a flowchart of a sequence for a decoder to determine an intra prediction mode of a current block using a template region according to a first embodiment of the present invention;

FIG. 3 shows a template region adjacent to a current block and pixels neighboring to the corresponding template region, which are used in used in obtaining an intra prediction mode of the template region adjacent to the current block according to a first embodiment of the present invention;

FIG. 4 is a flowchart for a sequence of obtaining a refined motion vector of a current block by performing template matching based on a motion vector of a current block according to a second embodiment of the present invention;

FIG. 5 shows a reference block corresponding to a current block and blocks neighboring to the corresponding reference block according to a second embodiment of the present invention;

FIG. 6 shows a method of determining a refined motion vector of a current block from a template matching performed result according to a second embodiment of the present invention;

FIG. 7 is a flowchart for a sequence of obtaining a refined motion vector of a current block according to a third embodiment of the present invention;

FIG. 8 shows a range of a candidate reference block for performing template matching with a current block, if a motion vector unit is ¼, according to a third embodiment of the present invention;

FIG. 9 shows a method of considering an inter illumination intensity difference in specifying a reference block corresponding to a current block according to a fourth embodiment of the present invention;

FIG. 10 is a syntax table on which a use of flag indicating whether to perform template matching is implemented according to a fifth embodiment of the present invention;

FIG. 11 is a syntax table on which a method of reordering a flag indicating whether to perform template matching is implemented according to a fifth embodiment of the present invention.

### DETAILED DESCRIPTION

### Best Mode

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of processing a video signal according to the present invention is to determine a intra prediction mode of a template region adjacent to a current block and to obtain a prediction value of the current block using the intra prediction mode of the template region as the intra prediction mode of the current block.

According to the present invention, the determining the intra prediction mode of the template region adjacent to the current block is to specify adjacent pixels at left, upper end, left upper end and right upper end of the template region, to calculate a pixel value difference between the specified pixel and the template region and to obtain a intra prediction mode minimizing the pixel value difference. The pixel value difference is calculated by considering nine kinds of prediction directions of the intra prediction mode.

To further achieve these and other advantages and in accordance with the purpose of the present invention, an apparatus for processing a video signal according to the present invention includes a prediction mode determining unit determining a prediction mode of a current block using a template region adjacent to the current block and an obtaining unit obtaining a prediction value of the current block using the prediction mode of the current block.

To further achieve these and other advantages and in accordance with the purpose of the present invention, a method of determining a motion vector according to the present invention is to specify a reference block pointed by the motion vector of the current block and blocks neighboring to the reference block, to calculate each pixel value difference between template regions of the specified blocks and a template region of the current block and to extract a refined motion vector based on a result of calculating the pixel value difference.

According to the present invention, the blocks neighboring to the reference block includes 8 blocks neighboring with a motion vector in quarter-pel unit.

According to the present invention, the extracting method of the refined motion vector of the current block is, if the pixel value difference between the template region of the current block and the template region of the reference block of the current block has a minimum value, to obtain a 2-dimensional curved surface based on 9 pixel value differences and to obtain a motion vector position having a minimum pixel value difference from the 2-dimensional curved surface.

To further achieve these and other advantages and in accordance with the purpose of the present invention, a method of determining a motion vector is to obtain a second motion vector difference value of the current block by applying a shift operation to a first motion vector difference value of the current block, to determine a range of candidate reference blocks based on the second motion vector difference value of the current block and a motion vector prediction value of the current block, to calculate each pixel value difference between the template regions of the candidate reference blocks and a template region of the current block and to obtain a refined motion vector of the current block from the candidate reference block minimizing the pixel value difference.

According to the present invention, the first motion vector difference value of the current block is a value obtained by applying a right shift operation to the motion vector difference value of the current block, the right shift operation is performed according to either round-down or round-off.

According to the present invention, if the first motion vector difference value of the current block is obtained by round-down, the range of the candidate reference block includes pixels ranging from a pixel at a motion vector position obtained from adding up the second motion vector difference value of the current block and the motion vector prediction value of the current block to an (X-1)^{th} pixel to the right, and if the first motion vector difference value of the current block is obtained by round-off, the range of the candidate reference block includes pixels ranging from a (X/2)^{th} pixel to the left from a pixel at the reference position to an (X/2-1)^{th} pixel to the right from the pixel at the reference position. The X is a value resulting from inverting a motion vector unit.

A method of processing a video signal according to the present invention, comprising calculating each pixel value differences between a template region of a current block and template regions of candidate reference blocks within a reference frame and using a candidate reference block minimizing the pixel value difference as a reference block corresponding to the current block.

According to the present invention, if a shape of current block is a rectangular shape, a template region is set in a manner that a shape resulting from combining the current block and a template region of the current block together has the same shape of the current block, and the template region of the current block includes a region of pixels adjacent to a right side or lower end of the current block as well as a region of pixels adjacent to a left side or upper end of the current block.

According to the present invention, calculating the pixel value difference includes adding an additional value to a pixel value of a candidate reference block by considering an illumination intensity difference between a current frame and a reference frame and using the pixel value of the candidate reference block.

A method of processing a video signal according to the present invention includes using a flag indicating whether a macroblock performs the template matching. If the macroblock is divided into M*N partitions, the flag is used for each of the partitions, and the flag information is received before receiving information on a type of the macroblock.

To further achieve these and other advantages and in accordance with the purpose of the present invention, an apparatus for processing a video signal according to the present invention includes a calculating unit calculating each pixel value difference between a template region of a current block and template regions of candidate reference block within a reference frame, a selecting unit selecting a reference block corresponding to a current block based on the pixel value difference, and a obtaining unit obtaining a prediction value of the current block using the selected reference block.

### Mode For Invention

Reference will now be made in detail to the preferred embodiments of the present invention, examples of which are illustrated in the accompanying drawings. First of all, terminologies in the present invention can be construed as the following references. And, terminologies not disclosed in this specification can be construed as the following meanings and concepts matching the technical idea of the present invention. Therefore, the configuration implemented in the embodiment and drawings of this disclosure is just one most preferred embodiment of the present invention and fails to represent all technical ideas of the present invention. Thus, it is understood that various modifications/variations and equivalents can exist to replace them at the timing point of filing this application.

Coding in the present invention should be understood as the concept for including both encoding and decoding. And a pixel value difference should be understood as a sum of an absolute value of a pixel value difference.

In the following description, a template usable for prediction of a current block is explained.

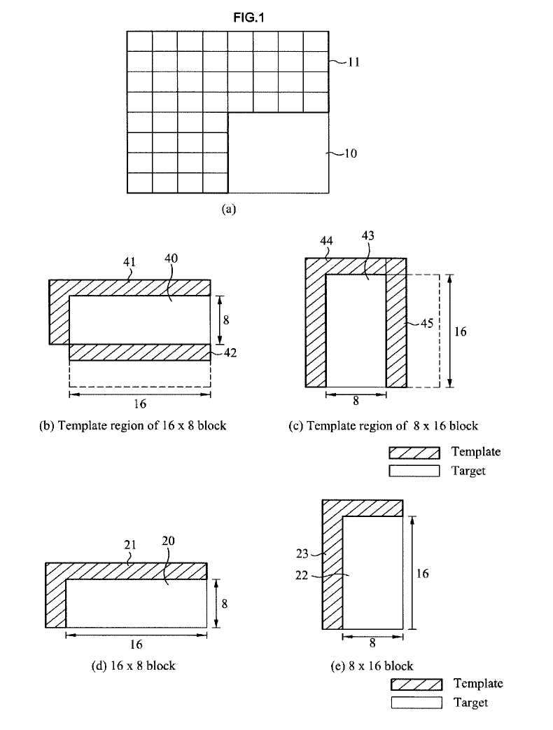

FIG. 1 shows an example of a template region and a target region.

Referring to FIG. 1(a), a target region (10) may mean a current block to be predicted by performing template matching. A template region (11) is a region adjacent to the target region and may include an already-coded region. Generally, the template region (11) can include a region adjacent to a left side and upper end edge of the target region (10).

Moreover, a region adjacent to a right side or lower end of the current block is coded ahead of the current block to be used as a template region in performing template matching.

For instance, referring to FIG. 1(b), a current block (40) is 16*8. A template region of the current block includes a lower end part (42) of the current block as well as an already coded region (41) adjacent to a left side and upper end of the current block.

Referring to FIG. 1(c), a template region of a current block (43) can include a region (45) adjacent to a right side of the current block as well as an already decoded region (44) adjacent to a left side and upper end of the current block.

It is able to set up a shape of a target according to a shape of a macroblock partition. And, it is able to set up a template region to enable a shape resulting from combining a template region and a target region to be equal to the shape of the target.

For instance, if a shape of a macroblock partition is 16*8 in FIG. 1(d), a target shape (20) can be defined into 16*8 block instead of 8*8 block. Further, if a shape of a target is defined into 16*8 block, it is able to set up a template region (21) to have the same shape of a shape resulting from combining a template region and a target region together, i.e., a rectangular shape.

If a shape of a macroblock partition is 8*16, a target shape (22) can be defined into 8*16 and a template region (23) can be set as shown FIG. 1(e).

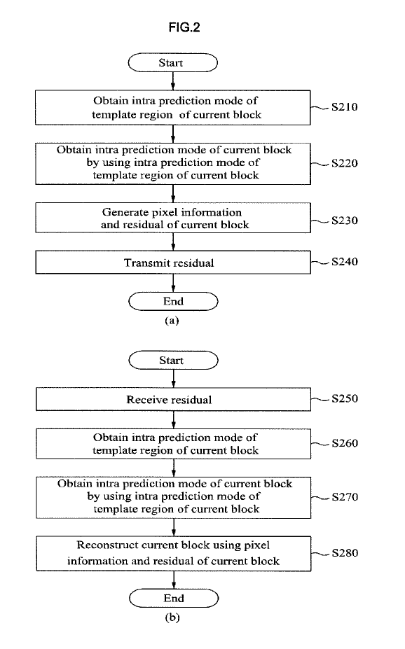

FIG. 2 is a flowchart of a sequence for a decoder to determine an intra prediction mode of a current block using a template region according to a first embodiment of the present invention.

Referring to FIG. 2(a), an encoder extracts an intra prediction mode of a template region adjacent to a current block [S210]. It is able to use the extracted intra prediction mode of the template region adjacent to the current block as an intra prediction mode of the current block using mutual similarity between the current block and the template region. Therefore, it is able to obtain the intra prediction mode of the current block [S220]. A pixel value and residual of the current block are generated in the intra-prediction mode of the current block [S230]. The residual of the current block is transferred to a decoder only [S240] but the intra prediction mode of the current block is not transmitted. Therefore, it is able to reduce an information size of the block transferred to the decoder.

Referring to FIG. 2(b), the decoder receives the residual of the current block [S250]. Like the encoder, the decoder obtains an intra prediction mode of the template region adjacent to the current block [S260] and then obtains the intra prediction mode of the current block [S270]. The current block is then reconstructed using a pixel value of the current block according to the obtained intra prediction mode of the current block and the received residual of the current block [S280].

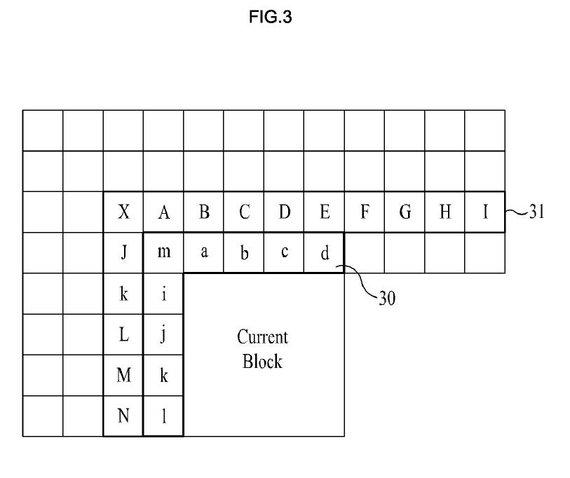

FIG. 3 shows a template region adjacent to a current block and pixels neighboring to the corresponding template region, which are used in obtaining an intra prediction mode of the template region adjacent to the current block according to a first embodiment of the present invention.

First of all, a˜m region (30) is adjacent to a left side and upper end of a current block and is also adjacent to a corner pixel located at a left upper end of the current block. The a˜m region (30) are already coded pixels and can be regarded as a template region. In FIG. 3, a size of the template region is 1. The size of the template region is n (n is a natural number) and is adjustable. A˜X region (31) includes coded pixels adjacent to left side (J˜N), upper end (A˜E), left upper end (X) and right upper end (F˜I) centering on the template region.

In order to select an optimal prediction mode, a pixel value difference between the a˜m region and the A˜X region is calculated. In case of a vertical mode, for example, a pixel value difference becomes absolute[(m−A)+(i−A)+(j−A)+(k−A)+(1−A)+(a−B)+(b−C)+(c−D)+(d−E)]. Likewise, the pixel value difference will be calculated for 9 kinds of the intra prediction modes. And, the intra prediction mode, which minimizes the pixel value difference, will become the intra prediction mode of the template region. Therefore, it is able to determine the intra prediction mode of the current block using the mutual similarity between the template region and the current block.

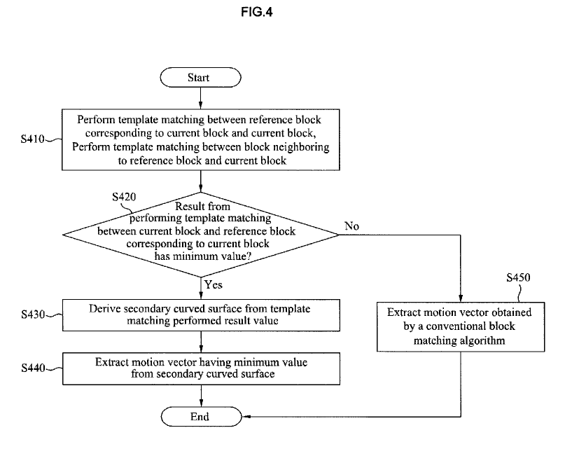

FIG. 4 is a flowchart for a sequence of obtaining a refined motion vector of a current block by performing template matching based on a motion vector of a current block according to a second embodiment of the present invention.

First of all, a decoder receives a motion vector difference value of a current block and then obtains a motion vector of the current block using the motion vector difference value of the current block and a motion vector prediction value of the current block. A reference block corresponding to the current block is specified using the motion vector of the current block and blocks neighboring to the specified reference block are specified.

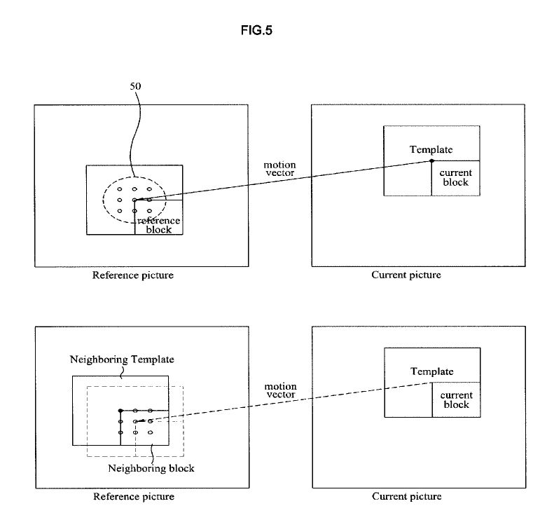

A pixel value difference between a template region of the current block and a template region of the specified reference block is calculated, and each pixel value differences between a template region of the current block and template regions of blocks neighboring to the specified reference block is calculated [S410]. If a pixel value difference between a template region of the current block and a template region of the reference block corresponding to the current block has a minimum value among the calculated pixel value differences, a method of determining a refined motion vector using a template matching suggested by the present invention is usable [S420]. But if a pixel value difference between a template region of the current block and a template region of the reference block corresponding to the current block does not have a minimum value among the calculated pixel value differences, a motion vector obtained by a conventional block matching algorithm is usable [S450]. The neighboring block shall be explained with reference to FIG. 5 later.

If a pixel value between a template of the current block and a template of the reference block corresponding to the current block does not have a minimum value, it is able to use a motion vector obtained by a conventional block matching algorithm.

If a pixel value between a template of the current block and a template of the reference block corresponding to the current block has a minimum value, it is able to derive a secondary curved surface from the pixel value difference obtained by performing the template matching [S430]. It is then able to obtain a motion vector that minimizes a pixel value difference on the curved surface [S440].

If a motion vector unit is ¼ in obtaining a motion vector using a conventional block matching algorithm, the refined motion vector unit can be (½)ⁿ⁺¹. (n is an integer) Performing a motion compensation, a pixel value below an integer pixel is generated by interpolation among pixel values of a reference picture.

For instance, in case that a refined motion vector unit is ⅛, a method generating ⅛ pixel value is explained.

First of all, ½ pixel value is generated by using six pixels placed on a horizontal line or a vertical line centering on the ½ pixel position. And ¼ pixel value is generated by using neighboring two pixels placed on a horizontal line, a vertical line or diagonal line centering on the ¼ pixel position. ⅛ pixel value is generated by using neighboring pixels placed on a horizontal line, a vertical line or diagonal line centering on the ⅛ pixel position. But if the ⅛ pixel and the neighboring pixels is placed on a horizontal line or a vertical line together, ⅛ pixel value is generated by using neighboring two pixels placed on a horizontal line or a vertical line centering on the ⅛ pixel position. If the ⅛ pixel and the neighboring pixels is placed on a diagonal line together, ⅛ pixel value is generated by using neighboring four pixels placed on a diagonal line centering on the ⅛ pixel position.

In the following description, a method of obtaining a refined motion vector is explained in detail.

FIG. 5 shows a reference block corresponding to a current block and blocks neighboring to the corresponding reference block according to a second embodiment of the present invention.

First of all, a block within a reference frame indicated by a motion vector of a current block will become a reference block corresponding to the current block. It is able to specify blocks neighboring by a motion vector unit interval centering on the reference block corresponding to the current block. Subsequently, a pixel value difference between a template region of the specified block and a template region of the current block is calculated. And, it is able to obtain nine pixel value differences from the calculated pixel vale difference. For instance, if a unit of a motion vector is ¼, a 9-pixel location (50) corresponds to pixels neighboring to one another by ¼ pixel interval centering on a pixel indicated by the motion vector of the current block. And, it is able to specify nine blocks for the nine pixels, respectively.

In the following description, a method of obtaining a refined motion vector from the nine pixel value differences is explained.

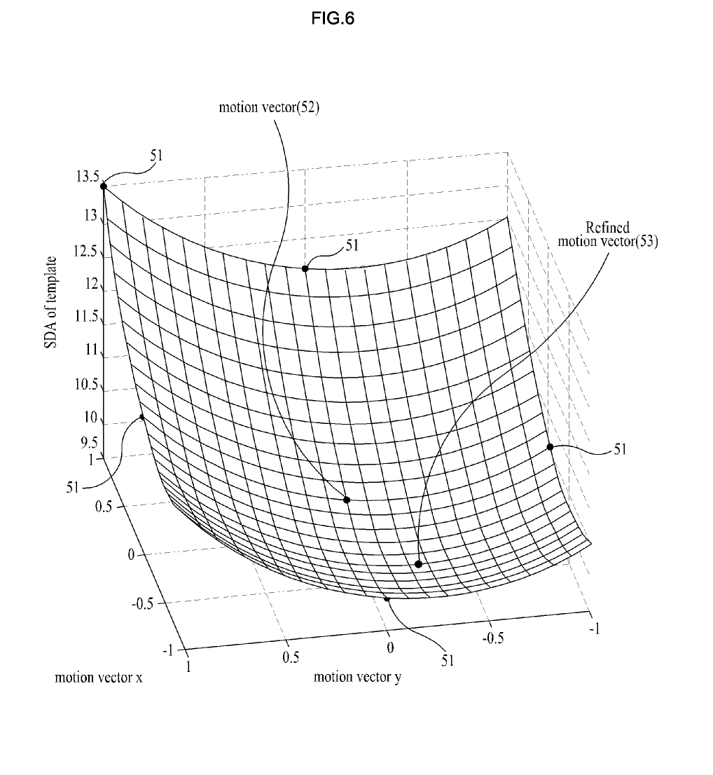

FIG. 6 shows a method of determining a refined motion vector of a current block from a template matching performed result according to a second embodiment of the present invention.

First of all, the nine pixel value differences can be placed on coordinates having X- and Y-axes set to a motion vector position and a Z-axis set to a pixel value difference. And, it is able to obtain a secondary curved surface in which six pixel value differences (51, 52) among nine pixel value differences correspond to roots. Since the case of a reference block corresponding to a current block (52) has a minimum value, it is able to place the case of the reference block corresponding to the current block (52) and the case of a block neighboring to the corresponding reference block (51) can be located as shown in FIG. 6. In this case, it is able to find a motion vector location (x, y) (53) having a pixel value difference set to a minimum from the secondary curved surface. The secondary curved surface can be represented as Formula 1.

S(x, y)=Ax2+By2+Cxy+Dx+Ey+F Formula 1

Values of x and y enabling the secondary curved surface S to have a minimum value satisfy zero if the S is differentiated with x and y. If Formula 1 is differentiated, Formula 2 and Formula 3 are generated.

dS/dx=2Ax+Cy+D=0 Formula 2

dS/dy=2Bx+Cy+E=0 Formula 3

If x and y satisfying Formula 2 and Formula 3 are found, Formula 4 is generated.

$$( \begin{matrix}x \\ y\end{matrix} ) = \frac{1}{4 AB - {C}^{2}} ( \begin{matrix}- 2 BD + CE \\ CD - 2 AE\end{matrix} ) \qquad [ Formula 4 ]$$

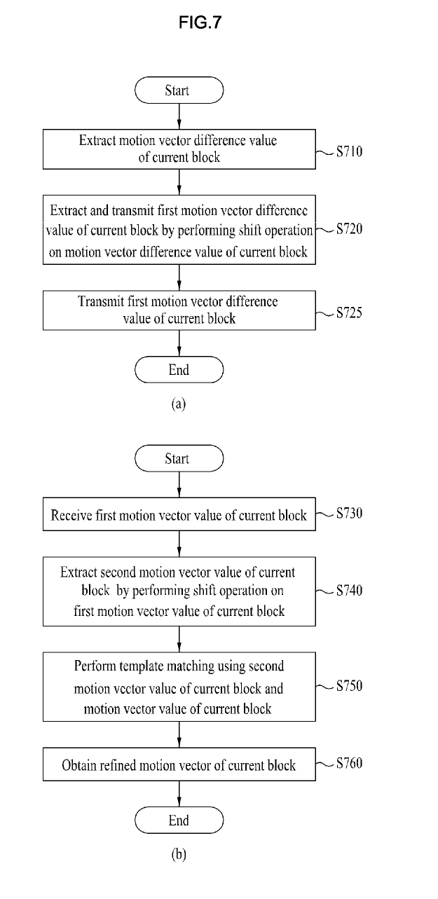

FIG. 7 is a flowchart for a sequence of obtaining a refined motion vector of a current block according to a third embodiment of the present invention.

In the following description, a candidate reference block is regarded as a candidate region that can become a reference block corresponding to a current block.

Referring to FIG. 7(a), an encoder obtains a motion vector prediction value of a current block and a motion vector of the current block and then obtains a motion vector difference value (mvd) of the current block from the obtained motion vector prediction value and the motion vector [S71O]. By performing a right-shift operation on the motion vector difference value (mvd) of the current block, it is able to obtain a first motion vector difference value (mvd′) of the current block of which accuracy is lowered [S720]. The first motion vector difference value (mvd′) of the current block is coded and then transferred to a decoder [S725]. Therefore, it is able to reduce a bit size required for transferring motion vector information.

Referring to FIG. 7(b), the decoder receives the first motion vector difference value (mvd′) of the current block of the current block [S730] and then extracts a second motion vector difference value (mvd″) of the current block by performing a left-shift operation on the received first motion vector difference value (mvd′) of the current block [S740]. The second motion vector difference value (mvd″) of the current block is extracted to perform template matching by a motion vector unit.

Subsequently, the template matching is performed with reference to a motion vector obtained from adding up the motion vector prediction value and the second motion vector difference value (mvd″) of the current block [S750]. A pixel value difference between a template region of the current block and a template region of the candidate reference block is calculated, and the candidate reference block minimizing the pixel value difference is used as a reference block corresponding to the current block. But the reference block may be equal to a reference block obtained by using the motion vector prediction value of a current block and the motion vector difference value (mvd) of the current block. It is then able to obtain a refined motion vector of the current block from the obtained reference block [S760].

In the following description, a range of a candidate reference block for performing template matching with a current block is explained.

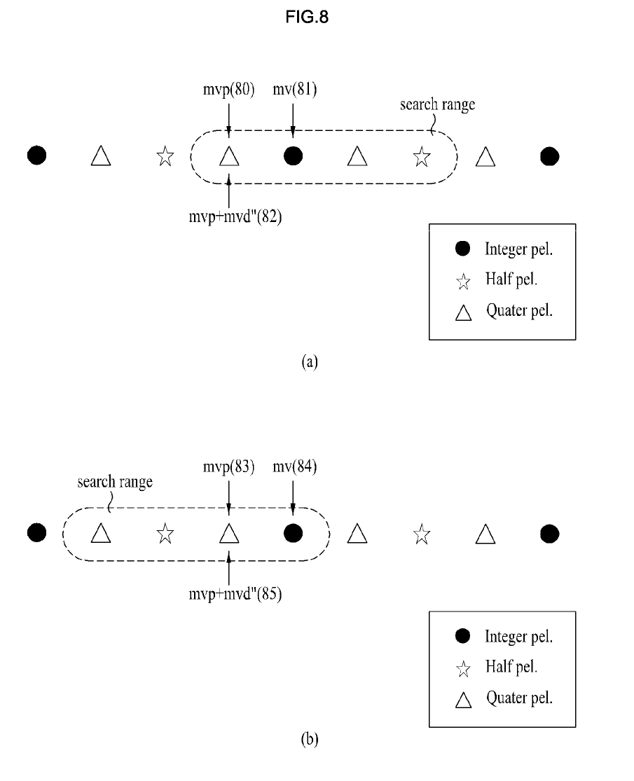

FIG. 8 shows a range of a candidate reference block for performing template matching with a current block, in case that a motion vector unit is ¼, according to a third embodiment of the present invention.

FIG. 8(a) shows an embodiment of a case resulting from round-down in obtaining a first motion vector difference value (mvd′) of a current block by performing a right shift operation on a motion vector difference value (mvd) of the current block.

If a motion vector prediction value of a current block (80) and a motion vector of the current block (81) are located as shown in FIG. 8(a), a motion vector difference value (mvd) of the current block becomes 1. And, it is able to obtain a first motion vector difference value (mvd′) of the current block by performing a shift operation represented as Formula 5.

mvd′=mvd′>>2=0 Formula 5

By performing a shift operation of Formula 6 on the first motion vector difference value (mvd′) of the current block to perform template matching by a motion vector unit, a second motion vector difference value (mvd″) of the current block is obtained.

mvd″=mvd′<<2 =0 Formula 6

A motion vector position (82) obtained from adding up the second motion vector difference value of the current block and the motion vector prediction value of the current block together is set to a reference pixel.

In obtaining the first motion vector difference value of the current block, the integer unit-accuracy value resulting from lowering accuracy of the motion vector difference value of the current block by performing the shift operation is extracted only and the lowered accuracy portion below an integer is rounded down. Therefore, the range of the candidate reference block will be from the reference pixel (82) up to the third to the right of the reference pixel (82).

FIG. 8(b) shows an embodiment of a case resulting from round-off in obtaining a first motion vector difference value (mvd′) of a current block by performing a shift operation on a motion vector difference value (mvd) of the current block.

If a motion vector prediction value of a current block (83) and a motion vector of the current block (84) are located as shown in FIG. 8(b), a motion vector difference value (mvd) of the current block is 1.

In order to extract an integer portion from the motion vector difference value (mvd) of the current block, a shift operation is operated to result in Formula 7.

mvd′=(mvd+2)>>2=0 Formula 7

Likewise, a second motion vector difference value (mvd″) of the current block is obtained by performing a shift operation of the first motion vector difference value (mvd′) of the current block.

mvd″=mvd′<<2=0 Formula 8

A motion vector position obtained from adding up the second motion vector difference value (mvd″) of the current block and the motion vector prediction value of the current block together is set to a reference pixel (85). Since FIG. 8(b) corresponds to the case of performing the round-off to obtain the first motion vector difference value (mvd′) of the current block, the range of the candidate reference block will be from the second to the left of the reference pixel (85) up to the first to the right.

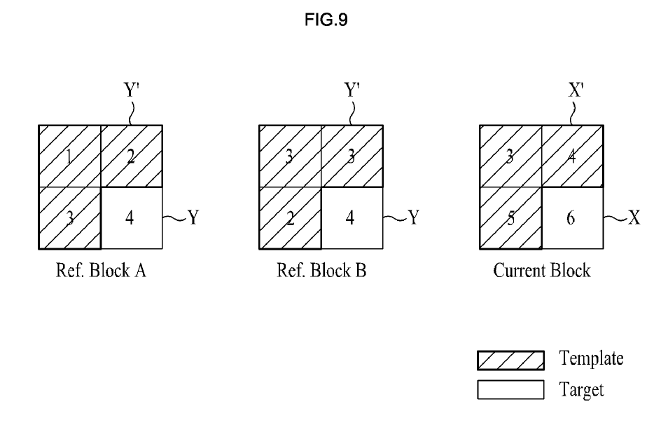

FIG. 9 shows a method of considering an inter illumination intensity difference in specifying a reference block corresponding to a current block according to a fourth embodiment of the present invention.

First of all, X indicates a predicted pixel value of a current block, X′ indicates a pixel value of a template region adjacent to the current block, Y indicates a pixel value of a candidate reference block, and Y′ indicates a pixel value of a template region adjacent to the candidate reference block.

If a pixel value of a current block is predicted using template matching without considering an illumination intensity difference, a pixel value difference between a template region adjacent to the current block an a template region adjacent to a candidate reference block becomes absolute[X′-Y′]. And, a candidate reference block, which minimized the pixel value difference, is specified as a reference block corresponding to the current block. Hence, in case of a candidate reference block A, a pixel value difference is ‘absolute[12−6]=6’. In case of a candidate reference block B, a pixel value difference is ‘absolute[12-4]=4’. Therefore, the candidate reference block B is selected as a reference block corresponding to a current block. And, a predicted pixel value of the current block is set to Y of the reference block B. In this case, the prediction value of the current block has distortion amounting to 2.

Yet, if an inter illumination intensity difference is taken into consideration, a pixel value difference (D) between a template region adjacent to a current block and a template region adjacent to a candidate reference block can be represented as Formula 9.

D=absolute[X′−(aY′+b)] Formula 9

In Formula 9, X′ indicates a pixel value of a template region adjacent to a current block, Y′ indicates a pixel value of a template region adjacent to a candidate reference block, and a and b indicate real numbers that minimize a pixel value difference, respectively.

If a pixel value difference between a template region adjacent to a candidate reference block A and a template region adjacent to a current block has a minimum value, the candidate reference block A can be selected as a reference block corresponding to the current block. In this case, if a and b, which minimize the pixel value difference, are 1 and 2, respectively, the pixel value difference becomes 0. And, a predicted pixel value X of the current block is predicted as ‘aY+b=6’. In this case, the current block becomes free from distortion.

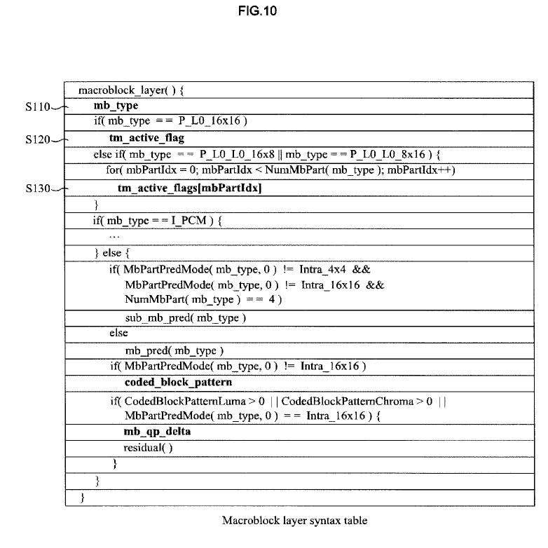

FIG. 10 is a syntax table on which a use of flag indicating whether to perform template matching is implemented according to a fifth embodiment of the present invention.

First of all, it is able to check whether to perform template matching for each type of a macroblock. For instance, it is able to use flag information indicating whether to perform template matching. Information on a macroblock type(mb_type) is received [S110]. If a type of a current macroblock is 16*16, it is able to receive flag information (tm_active_flag) indicating whether to perform template matching in prediction of the current macroblock [S120].

Moreover, if a type of a current macroblock is 16*8 or 8*16, it is able receive flag information (tm_active_flags[mbPartIdx]) indicating whether to perform template matching on each partition [S130]. Therefore, by using flag information indicating whether to perform template matching on each type of a macroblock, template matching can be adaptively performed.

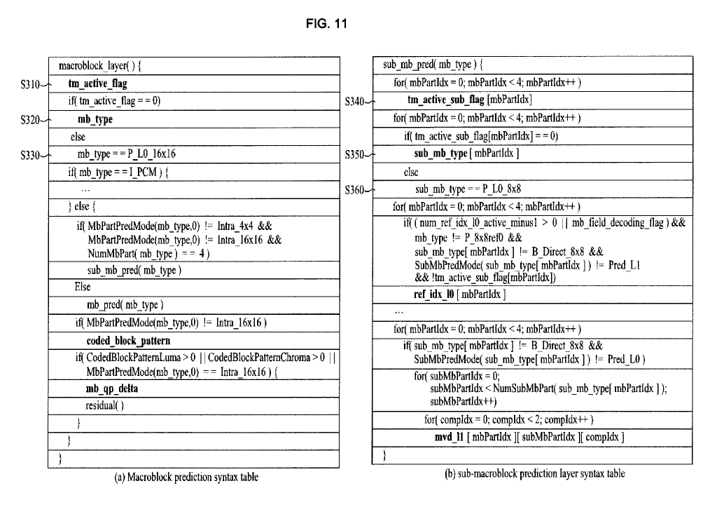

FIG. 11 is a syntax table on which a method of reordering a flag indicating whether to perform template matching is implemented according to a fifth embodiment of the present invention.

First of all, flag information indicating whether to perform template matching is received ahead of receiving information on a type of a macroblock [S310]. If the flag information indicates not to perform the template matching, the information on the type of the macroblock is received to use a conventional decoding scheme [S320].

If the flag information indicates to perform the template matching, it is able to set a type of the macroblock to 16*16 instead of decoding the information on the type of the macroblock [S330].

Likewise, in case of a sub-macroblock, flag information indicating whether to perform template matching on each partition within a sub-macroblock is received [S340]. If the flag information indicates not to perform the template matching, the information on a partition within a macroblock is received to use a conventional decoding scheme [S350].

If the flag information indicates to perform the template matching, it is able to set a type of the sub-macroblock to 8*8 [S360].

### INDUSTRIAL APPLICABILITY

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A method of processing a video signal, comprising:
determining an intra prediction mode of a current block using a template region adjacent to the current block; and
obtaining a prediction value of the current block using the intra prediction mode of the current block.

2. The method of claim 1, the determining the intra prediction mode of the current block using the template region adjacent to the current block, further comprising extracting an intra prediction mode of the template region adjacent to the current block, wherein the intra prediction mode of the template region adjacent to the current block is used as the intra prediction mode of the current block.

3. The method of claim 2, the extracting the intra prediction mode of the template region adjacent to the current block, further comprising:
calculating a pixel value differences between pixels of the template region adjacent to the current block and adjacent pixels at left, upper end, left upper end and right upper end of the template region, respectively; and
obtaining the intra prediction mode minimizing the pixel value difference, wherein the pixel value differences are calculated by considering nine kinds of prediction directions of the intra prediction mode.

4. An apparatus for processing a video signal, comprising:
a prediction mode determining unit determining a prediction mode of a current block using a template region adjacent to the current block; and
an obtaining unit obtaining a prediction value of the current block using the prediction mode of the current block.

5. A method of determining a motion vector, comprising:
receiving a motion vector difference value of a current block;
obtaining a motion vector of the current block using the received motion vector difference value of the current block and a motion vector prediction value of the current block;
specifying a reference block corresponding to the current block and blocks neighboring to the reference block using the motion vector of the current block;
calculating each pixel value difference between template regions of the specified blocks and a template region of the current block; and
extracting a refined motion vector based on a result of calculating the pixel value differences.

6. The method of claim 5, wherein the blocks neighboring to the reference block comprise 8 blocks neighboring with a motion vector unit interval centering on the reference block.

7. The method of claim 5, the extracting the refined motion vector, further comprising, if the pixel value difference between the template region adjacent to the current block and the template region adjacent to the reference block corresponding to the current block has a minimum value, obtaining a motion vector position having a minimum pixel value difference from a secondary curved surface based on 9 pixel value differences.

8. A method of determining a motion vector, comprising:
receiving a first motion vector difference value of a current block;
obtaining a second motion vector difference value of the current block by applying a shift operation to the first motion vector difference value of the current block;
determining a range of candidate reference blocks based on the second motion vector difference value of the current block and a motion vector prediction value of the current block;
calculating each pixel value difference between template regions adjacent to the candidate reference blocks and a template region adjacent to the current block; and
obtaining a motion vector of the current block based on a result of calculating the pixel value differences.

9. The method of claim 8, wherein the first motion vector difference value of the current block is a value resulting from lowering accuracy of the motion vector difference value of the current block by a right shift operation and wherein the right shift operation for the motion vector difference value of the current block is performed according to either round-down or round-off.

10. The method of claim 8, wherein in the determining the range of the candidate reference block, if the first motion vector difference value of the current block is obtained by round-down, the range of the candidate reference block includes pixels ranging from a pixel at a motion vector position (reference position) obtained from adding up the second motion vector difference value of the current block and the motion vector prediction value of the current block to an (X−1)th pixel to the right and wherein the X is a value resulting from inverting a motion vector unit.

11. The method of claim 8, wherein in the determining the range of the candidate reference block, if the first motion vector difference value of the current block is obtained by round-off, the range of the candidate reference block includes pixels ranging from a (X/2)th pixel to the left from a pixel at the reference position to an (X/2-1)th pixel to the right from the pixel at the reference position and wherein the X is a value resulting from inverting a motion vector unit.

12. The method of claim 8, wherein the obtaining the motion vector of the current block obtains the motion vector of the current block from the candidate reference block minimizing the pixel value difference as a result of performing template matching.

13. A method of processing a video signal, comprising:
calculating a pixel value difference between a template region of a current block and a candidate template region of a reference frame, wherein the template region of the reference frame is selected based on the pixel value difference,
selecting a reference block of the current block by using template matching in the template region of the current block and the template region of the reference frame; and
obtaining a prediction value of the current block using the selected reference block decoding the current block based on the prediction value.

14. The method of claim 13, wherein the calculating a pixel value difference between a template region adjacent to the current block and a candidate template region within a reference frame considers an illumination intensity difference between a current frame and a reference frame.

15. The method of claim 14, wherein a template region adjacent to the current block includes a region of pixels adjacent to a right side or lower end of the current block.
